(19) United States
(12) Patent Application Publication
(10) Pub. No.: US 2007/0292095 A1
(43) Pub. Date: Dec. 20, 2007

(54) FIXING BOARD AND POLISHING DEVICE USING THE SAME

(75) Inventor: Cheng-Yu Chung, Hsinchu County (TW)

Correspondence Address: THOMAS, KAYDEN, HORSTEMEYER & RISLEY, LLP, 600 GALLERIA PARKWAY, STE 1500, ATLANTA, GA, 30339, US

(73) Assignee: CANDO CORPORATION, Hsinchu County (TW)

(21) Appl. No.: 11/765,508

(22) Filed: Jun. 20, 2007

(30) Foreign Application Priority Data
Jun. 20, 2006 (TW) 95122146

(51) Int. Cl. G02B 6/00

(52) U.S. Cl. 385/137

(57) ABSTRACT

A fixing board and a polishing device using the same are provided. The fixing board attached to the non-semiconductor substrate includes a soft film and several films. The films are disposed on part of the soft film and substantially corresponding to a first surface of the non-semiconductor substrate.

This application claims the benefit of Taiwan Application No. 095122146, filed Jun. 20, 2006, the contents of which are herein incorporated by reference in its entirety.

### BACKGROUND OF THE INVENTION

1. Field of the Invention

The present invention relates in general to a fixing board and a polishing device using the same and, more particularly, to a fixing board for attaching to a non-semiconductor substrate and a polishing device for polishing the non-semiconductor substrate.

2. Description of the Related Art

The polishing process is very important in the manufacture of precision electronic devices for maintaining the flatness of the substrate. Electronic devices, such as display panels, MEMS (micro-electro-mechanical-system) devices, package devices or semiconductor devices, have strict requirement of the surface flatness of the substrates. Take the display panel as example. The color displayed by the display panel is presented through a color filter (CF) including several pixels. Each pixel has a primary color, such as red, green, or blue. Different color can be presented by mixing the three primary colors with different scales. The pixel of the color filter is made of photoresist containing a pigment.

Referring to FIG. 1, a color filter 990 is illustrated in FIG. 1. The color filter 990 includes a substrate 991 and several pixels 992. Each pixel 992 is made of photoresist containing a pigment. Due to factors including process parameters and facilities, horn-shaped structure 993 is formed on two sides of the pixel 992, and photoresist residual is left on surface of the pixel 992. The horn-shape structure 993 and the photoresist residual affect the display quality of the panel. Generally, a polishing process is performed on the pixels to remove the horn-shaped structure 993 and the photoresist residual, so that the substrate 991 is planarized.

Referring to FIG. 2, a conventional polishing device 900 is illustrated in FIG. 2. The polishing device 900 includes a supporting substrate 910, a fixing board 920, a polishing plate 930, a holder 940, and a liquid injector 970. The supporting substrate 910 is for carrying the substrate 991. The fixing board 920 is disposed on the supporting substrate 910 for adhering to the substrate 991.

The conventional fixing board 920 includes a soft film 921 for attaching to a first surface 991a of the substrate 991, so that the substrate 991 is not swaying or even separated from the supporting substrate 910 in the polishing process. As a result, the substrate 991 is prevented from cracking. The polishing plate 930 is for polishing a second surface 991b of the substrate 991. The liquid injector 970 is for injecting liquid 971 onto the second surface 991b, so that the polishing plate 930 moves and spins on the moistened second surface 991b more smoothly.

Referring to FIG. 3, an enlarged view of a dotted area 3 in FIG. 2 is shown in FIG. 3. The liquid injector 970 also injects the liquid 971 onto the first surface 991a of the fixed board 920, such as the first surface 991a of the soft film 921. The soft film 921 includes a foam material. After the liquid 971 permeates into the soft film 921, a vacuum is formed between the soft film 921 and the first surface 991a for generating an adhesive force. Therefore, no matter how the substrate 991 spins in the polishing process, the soft film 921 is attached to the substrate 991 tightly. The substrate 991 is not separated from the fixing board 920 over the supporting substrate 910.

Referring to both FIG. 4 and FIG. 2. FIG. 4 is a top view of the supporting substrate 910 and the substrate 991 in FIG. 2. The polishing device 900 further includes four air guns 960 disposed around the supporting substrate 910. After the polishing device 900 finishes the polishing process, the supporting substrate 930 moves away from the first surface 991a of the substrate 991. When the holder 940 clamps the substrate 991, the air guns 960 must blow the liquid 971 toward the first surface 991a, and so as to reduce the adhesive force between the first surface 991a and the soft film 921.

However, as the air guns 960 is only blow to the edges of the substrate 991 can be caused the liquid 971 easily remains between the substrate 991 and soft film 921. Also, the gravity force of the substrate 991 is concentrated at the center of the substrate 991. As a result, the edges and the center of the substrate 991 are often deformed when the substrate 991 is lifted up by the holder 940. Therefore, the conventional fixing board 920 and the polishing device 900 using the same have the following problems which are difficult to be solved.

1. When the holder 940 lifts up the substrate 991, the air guns 960 are used for blowing liquid 971. However, the adhesive force between the substrate 991 and the soft film 921 is only reduced slightly. The substrate 991 is deformed easily due to the adhesive force and the gravity force of the substrate 991. When deformed to a certain level, the substrate 991 cracks which increases the defective rate.

2. In order to prevent the substrate from cracking, the speed of the holder 940 to lift up the substrate 991 is reduced. Although the deformation of the substrate 991 is alleviated, the manufacturing time is increased greatly, and the throughput is reduced.

3. When the substrate 991 cracks, it is unusable and cannot be reworked, must to discard the cracked substrate as junk, and then the produces cost is increased greatly. Even when the speed of the holder 940 to lift up the substrate 991 slows down which prevents the substrate 991 from cracking, the cost for the increased time is considerably expensive.

Therefore, it is very important to develop a fixing board and a polishing device using the same which are able to alleviate the above problems.

### SUMMARY OF THE INVENTION

The present invention is directed to a fixing board and a polishing device using the same. Several films are disposed on the soft film, so that the non-semiconductor substrate is lifted up smoothly. The problem that the non-semiconductor substrate cracks in the lifting process is reduced.

According to the present invention, a fixing board attached to a non-semiconductor substrate is provided. The fixing board includes a soft film and several films. The films are disposed on part of the soft film and substantially corresponding to a first surface of the non-semiconductor substrate.

According to the present invention, a polishing device including a supporting substrate, a fixing board, a polishing plate, and several first holders is provided. The supporting substrate is adapted to support a non-semiconductor substrate. The fixing board is disposed over the supporting substrate attached to the non-semiconductor substrate. The fixing board includes a soft film and several films. The films are disposed on the soft film and substantially corresponding to a first surface of the non-semiconductor substrate. The polishing plate is adapted to polish a second surface of the non-semiconductor substrate. The first holders are adapted to hold the non-semiconductor substrate away from the supporting substrate or place on the supporting substrate. At least part of the films are substantially corresponding to the first holders.

According to the present invention, a polishing device including a supporting substrate, a fixing board, a polishing plate, and several first holders is provided. The supporting substrate is adapted to support a non-semiconductor substrate. The fixing board is disposed on the supporting substrate attached to the non-semiconductor substrate. The fixing board includes a soft board and several films. The films are disposed on the soft film and substantially corresponding to a first surface of the non-semiconductor substrate. The polishing plate is adapted to polish a second surface of the non-semiconductor substrate. The first holders are adapted to hold the non-semiconductor substrate away from the supporting substrate or placed on the supporting substrate. At least part of the films are not substantially corresponding to the first holders.

According to the present invention, a polishing device including a supporting substrate, a fixing board, a polishing plate, and a fluid injector is provided. The supporting substrate is adapted to support a non-semiconductor substrate. The fixing board is disposed on the supporting substrate attached to the non-semiconductor substrate. The fixing board includes a soft film and several films. The films are disposed on the soft film and substantially corresponding to a first surface of the non-semiconductor substrate. The polishing plate is adapted to polish a second surface of the non-semiconductor substrate. The fluid injector is adapted to inject fluid onto the surfaces of the non-semiconductor substrate. At least part of he films are substantially corresponding to a flowing path of the fluid.

The present invention will become apparent from the following detailed description of the preferred but non-limiting embodiments. The following description is made with reference to the accompanying drawings.

### BRIEF DESCRIPTION OF THE DRAWINGS

FIG. 1 illustrates a conventional color filter;

FIG. 2 illustrates a conventional polishing device;

FIG. 3 is an enlarged view of a dotted area 3 in FIG. 2;

FIG. 4 is a top view of a supporting substrate and a substrate in FIG. 2;

FIGS. 5A˜5C illustrate a fixing board and a polishing device using the same according to a first embodiment of the present invention;

FIG. 6 is an enlarged view of a dotted area 6 in FIG. 5C;

FIG. 7A is a top view of the supporting substrate and the fixing board in FIG. 5C;

FIG. 7B is a top view of the supporting substrate, the fixing board and the non-semiconductor substrate in FIG. 7A;

FIG. 8A is a top view of the supporting substrate and the fixing board according to a second embodiment of the present invention;

FIG. 8B a top view of the supporting substrate, the fixing board and the non-semiconductor substrate according to the second embodiment of the present invention;

FIG. 9A is a top view of the supporting substrate and the fixing board according to a third embodiment of the present invention;

FIG. 9B a top view of the supporting substrate, the fixing board and the non-semiconductor substrate according to the third embodiment of the present invention;

FIG. 10A is a top view of the supporting substrate and the fixing board according to a fourth embodiment of the present invention;

FIG. 10B is a top view of the supporting substrate, the fixing board and the non-semiconductor substrate according to the fourth embodiment of the present invention;

FIG. 11 illustrates the process that first holders in FIG. 10B lift up the non-semiconductor substrate;

FIG. 12A is a top view of the supporting substrate and the fixing board according to a fifth embodiment of the present invention;

FIG. 12B is a top view of the supporting substrate, the fixing board and the non-semiconductor substrate according to the fifth embodiment of the present invention;

FIG. 13A is a top view of the supporting substrate and the fixing board according to a sixth embodiment of the present invention;

FIG. 13B is a top view of the supporting substrate, the fixing board and the non-semiconductor substrate according to the sixth embodiment of the present invention;

FIG. 14A is a top view of the supporting substrate and the fixing board according to a seventh embodiment of the present invention;

FIG. 14B is a top view of the supporting substrate, the fixing board and the non-semiconductor substrate according to the seventh embodiment of the present invention;

FIG. 15A is a top view of the supporting substrate and the fixing board according to an eighth embodiment of the present invention; and

FIG. 15B is a top view of the supporting substrate, the fixing board and the non-semiconductor substrate according to the eighth embodiment of the present invention.

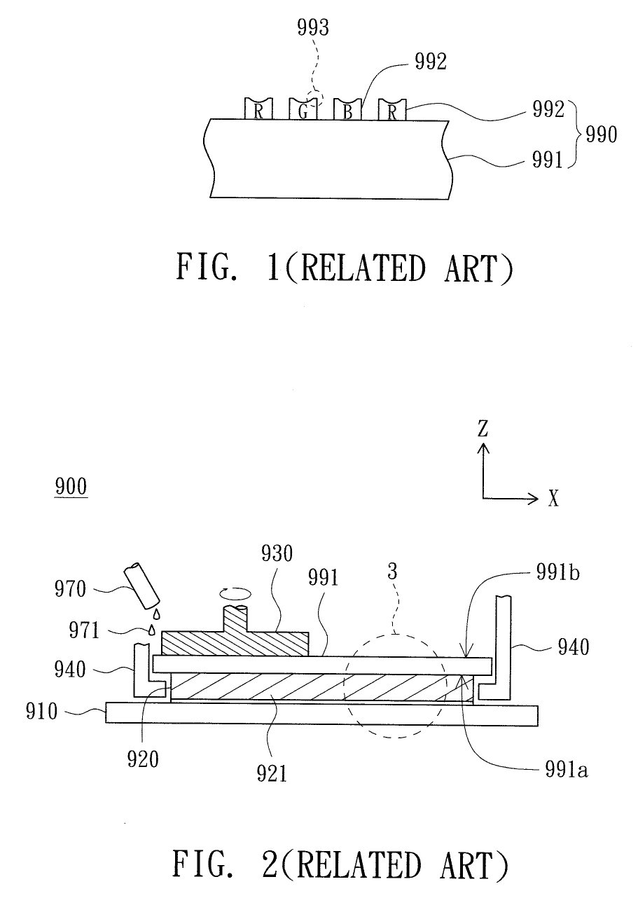

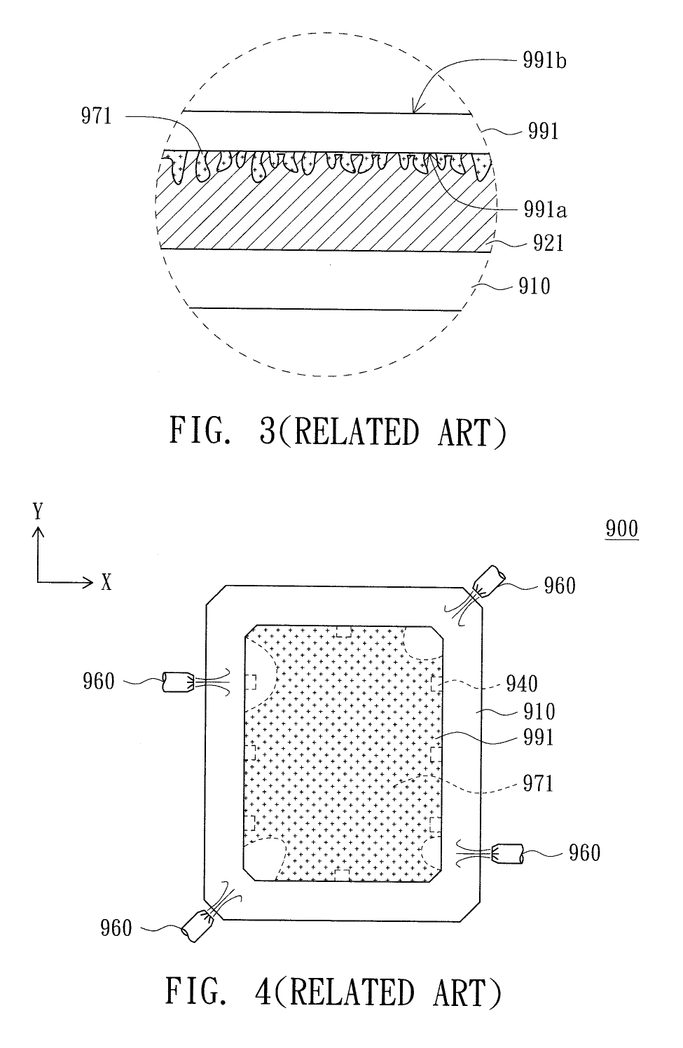

### DETAILED DESCRIPTION OF THE INVENTION

### First Embodiment

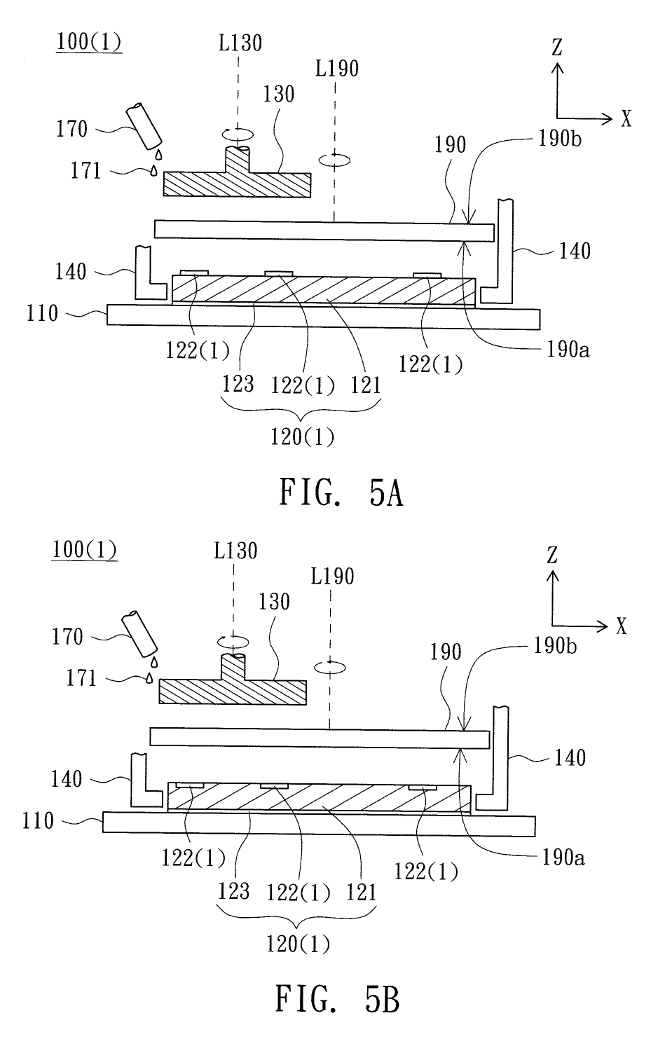

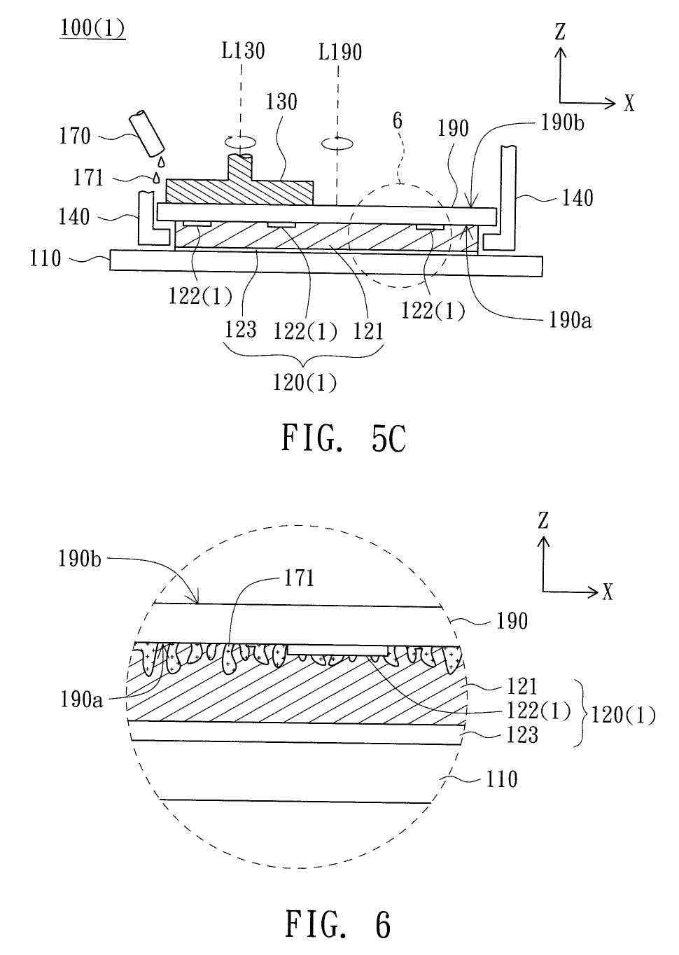

Referring to FIGS. 5A˜5C, a fixing board 120 and a polishing device 100(1) using the same according to a first embodiment of the present invention are illustrated in FIGS. 5A˜5C. The polishing device 100(1) includes a supporting substrate 110, a fixing board 120(1), a polishing plate 130, and several first holders 140. The supporting substrate 110 is adapted to support or to carry a non-semiconductor substrate 190 or a namely insulating substrate. The material of the non-semiconductor substrate or the material of insulating substrate comprises transparent material (such as glass, quartz, or others), non-transparent material (such as ceramic, or others), or flexible material (such as plastic, rubber, polyester, poly alcohol, poly acrylate, polycarbonate, poly styrene, others). Generally speaking, the supporting substrate 110 is substantially greater than the non-semiconductor substrate 190, but not-limited it. The fixing board 120(1) is disposed on the supporting substrate 110 attached to the non-semiconductor substrate 190. The fixing board 120(1) includes a soft film 121 and several films 122(1). The films 122(1) are disposed on the soft film 121 and substantially corresponding to a first surface 190a of the non-semiconductor substrate 190. The polishing plate 130 is adapted to polish a second substrate 190b of the non-semiconductor substrate 190. Generally speaking, the polishing plate 130 is substantially greater than half of the non-semiconductor substrate 190. In other words, the polishing plate 130 is substantially smaller than the non-semiconductor substrate 190. The holders 140 are adapted to hold the non-semiconductor substrate 190 away from fixing board 120(1) of the supporting substrate 110 or placed on fixing board 120(1) of the supporting substrate 110. Or namely The holders 140 are adapted to hold the non-semiconductor substrate 190 away from the supporting substrate 110 or placed on the supporting substrate 110.

The films 122(1) can be disposed on the soft film 121 as shown in FIG. 5A. Or, as shown in FIG. 5B, the films 122(1) can be embedded into the soft film 121, and the upper surfaces of the films 122(1) are exposed to the surrounding. In other words, the upper surface of the films 122(1) and the upper surface of the soft film 121 exist on a substantially identical horizontal. As shown in FIG. 5C, when the non-semiconductor substrate 190 is attached to the soft film 121 and the films 122(1), the gravity force of the non-semiconductor substrate 190 is applied to the soft film 121. As a result, the films 122(1) and the soft film 121 are attached to the first surface 190a of the non-semiconductor substrate 190 flatly.

Furthermore, the non-semiconductor substrate 190 comprises a transparent substrate, an opaque substrate, or a flexible substrate. The transparent substrate comprises glass, quartz, or others, or combinations thereof. The opaque substrate comprises ceramics, or others, or combinations thereof. The flexible substrate comprises plastic, rubber, PET, PE, or others, or combinations thereof. In the present embodiment, the non-semiconductor substrate is a transparent substrate made of glass as an example.

Moreover, the non-semiconductor substrate 190 includes photoresist or other components. The photoresist includes substantially different pigments. In the present embodiment, color photoresist is formed on the glass substrate to be a color filter (CF) as an example.

In the present embodiment, the fixing board 120(1) is incorporated to the polishing device 100(1) as an example. However, the fixing board of the present invention can be applied to different kinds of devices. The present invention encompasses all the modifications as long as a fixing board with a soft film and several films disposed thereon is attached to a non-semiconductor substrate.

Referring to FIGS. 5A˜5C. When the polishing device 100(1) polishes the non-semiconductor substrate 190, the supporting substrate 110 drives the non-semiconductor substrate 190 to rotate around a central axis L190 of the non-semiconductor substrate 190. The polishing plate 130 is attached to the second substrate 190b of the substrate 190 and moves back and forth along the X-axis in the drawings, and the polishing plate 130 is rotated around a central axis L130 of the polish plate. Also, the polishing plate 130 is able to polish the entire second surface 190b. Preferably, the rotated direction of the polishing plate 130 is substantially different from that of the non-semiconductor substrate 190 driven by the supporting substrate 110 in order to have better polishing effect.

Preferably, the polishing device 100(1) further includes a fluid injector is adapted to inject fluid, such as liquid, gas, or combinations thereof. In the present embodiment, the fluid injector includes a liquid injector 170 is adapted to inject liquid 171 onto at least one of the first surface 190a and the second surface 190b of the non-semiconductor substrate 190, as shown in FIG. 5C. The liquid 171 is injected onto the second surface 190b, so that the polishing plate 130 polishes the second surface 190b smoothly. Preferably, the liquid 171 is chemically corrosive is adapted to increase the speed of the polishing plate 130 to polish the second surface 190b.

The soft film 121 of the fixing board 120 is attached to the first surface 190a of the non-semiconductor substrate 190. The soft film 121 prevents the non-semiconductor substrate 190 from swaying in the polishing process, so that the non-semiconductor substrate 190 is not separated from the supporting substrate 110. As a result, the non-semiconductor substrate 190 is prevented from cracking.

Referring to FIG. 6. FIG. 6 is an enlarged view of a dotted area 6 in FIG. 5C. The liquid injector 170 injects liquid 171 onto the first surface 190a, so that the soft film 121 is attached to the first surface 190a better. The soft film 121 includes a foam layer which comprises polyurethane (PU), PE, PET, PP, PMMA, or others, or combinations thereof. After the liquid 171 permeates into of the gaps the soft film 121, an adhesive force is formed between the soft film 121 and the first surface 190a. Accordingly, the soft film 121 is attached to the non-semiconductor substrate 190 tightly no matter how the non-semiconductor substrate 190 rotates. Therefore, the non-semiconductor substrate 190 is not separated from the supporting substrate 110 when rotating.

Furthermore, as shown in FIG. 6, the films 122(1) are disposed on the soft film 121 and substantially corresponding to the first surface 190a of the non-semiconductor substrate 190. The films 122(1) comprise a hydrophobic material or an oleophilic material, such as teflon, carbon fluoride polymer, polymer (such as macromolecule), or combinations thereof. In the present embodiment, the films 122(1) are made of teflon as an example.

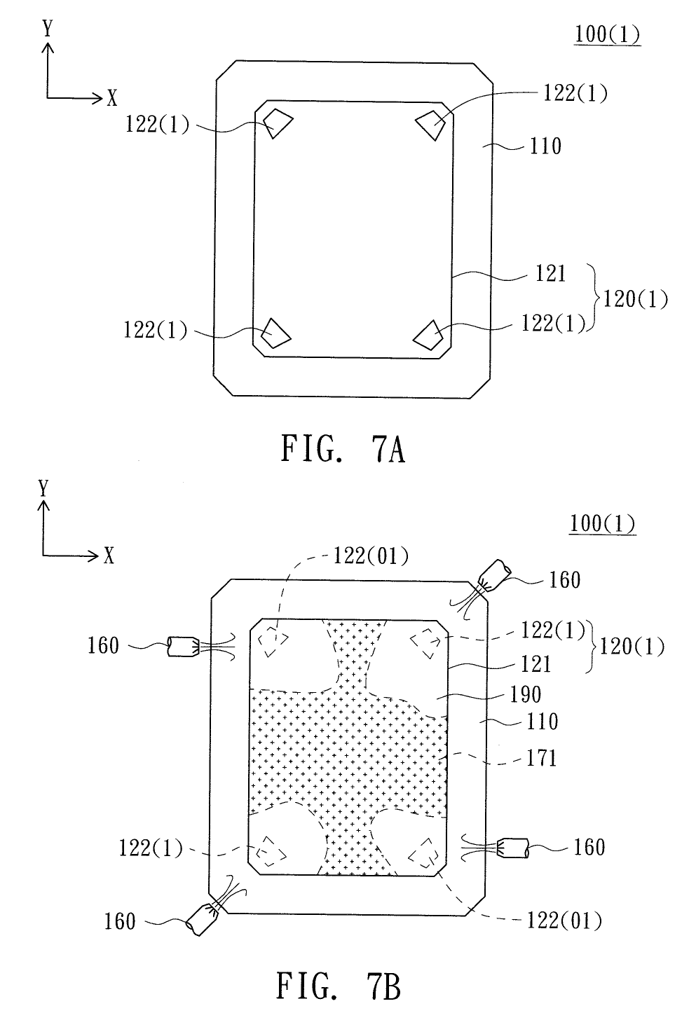

Referring to FIGS. 5C and 7A at the same time. FIG. 7A is a top view of the supporting substrate 110 and the fixing board 120(1) in FIG. 5C. In the present embodiment, the films 122(1) are disposed in a place, in which on four corners of the soft film 121. Because the films 122(1) are hydrophobic, the liquid 171 flows away from the four corners quickly which the soft films 122(1) are disposed on.

Referring to both FIG. 5C and FIG. 7B. FIG. 7B is a top view of the supporting substrate 110, the fixing board 120(1) and the non-semiconductor substrate 190 in FIG. 7A. The liquid injector of the polishing device 110(1) further includes at least a gas injector 160 disposed around the supporting substrate 110. When the polishing device 100(1) finished the polishing process, the supporting substrate 130 moves away from the first surface 190a of the non-semiconductor substrate 190. When the first holders 140 lift up the non-semiconductor substrate 190, the gas injector 160 injects gas toward the first surface 190a. Because the hydrophobic films 122(1) are disposed on four corners of the soft film 121, the liquid 171 flows away from the four corners quickly. Accordingly, the adhesive force between the non-semiconductor substrate 190 and the soft film 121 is reduced greatly, and the non-semiconductor substrate 190 is prevented from deformation.

Moreover, the films 122(1) are disposed only on four corners of the soft film 121, so that a certain level of the adhesive force is between the soft film 121 and the non-semiconductor substrate 190. The non-semiconductor substrate 190 is not separated from the soft film 121 when rotating.

Referring to FIG. 6. The fixing board 120(1) further includes a supporting base 123 disposed under the soft film 121. The supporting base 123 comprises polymer such as non-woven fabric, but not-limited it. Also, the supporting base 123 is an interface between the supporting substrate 110 and the soft film 121.

The films 122(1) of the present embodiment are shaped and disposed as shown FIG. 7A. However, the films of the present invention can have other shapes and be disposed at other locations or other places. The shape and locations of the films are adjustable according to the polishing device and the non-semiconductor substrate, and the present invention encompasses such modifications. The first holders lift up the non-semiconductor substrate smoothly, and a certain level of the adhesive force is still maintained. Several embodiments are described as follow to illustrate different kinds of arrangement and the effect.

### Second Embodiment

The fixing board 120(2) and the polishing device 100(2) using the same of a second embodiment and those of the first embodiment are different in the locations of the films 122(2). Other parts are the same and not described repeatedly.

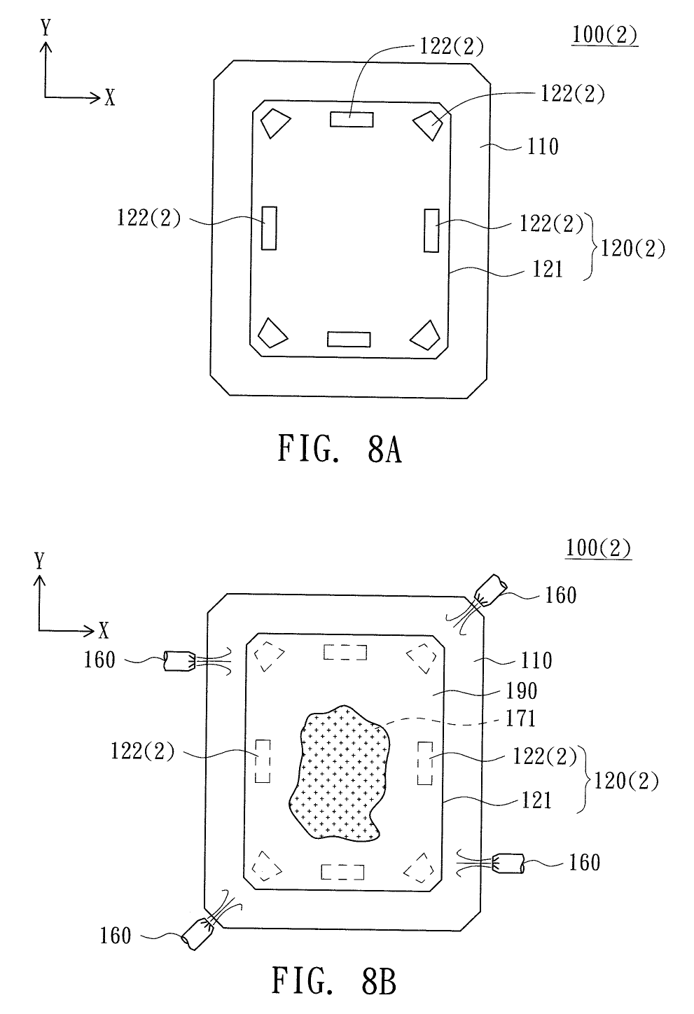

Referring to FIG. 8A. FIG. 8A is a top view of the supporting substrate 110 and the fixing board 120(2) according to the second embodiment of the present invention. In the present embodiment, some of the films 122(2) are disposed in a place, in which between the adjacent corners of the soft film 121. In additional, when the present embodiment, preferred, is incorporated in the first embodiment, due to the films 122(2) are hydrophobic, the liquid 171 quickly flows away from the four corners and the regions between the adjacent corners.

Referring to FIG. 8B. FIG. 8B is a top view of the supporting substrate 110, the fixing board 120(2) and the non-semiconductor substrate 190 according to the second embodiment of the present invention. The hydrophobic films 122(2) of the present embodiment are disposed on four corners and regions between the adjacent corners of the soft film 121 as an example, the liquid 171 flows away from four corners of the soft film 121 quickly. Accordingly, the adhesive force between the non-semiconductor substrate 190 and the soft film 121 is reduced significantly, and the non-semiconductor substrate 190 is prevented from deformation.

### Third Embodiment

The fixing board 120(3) and the polishing device 100(3) using the same of a third embodiment and those of the second embodiment are different in the locations of the films 122(3). Other parts are the same and not described repeatedly.

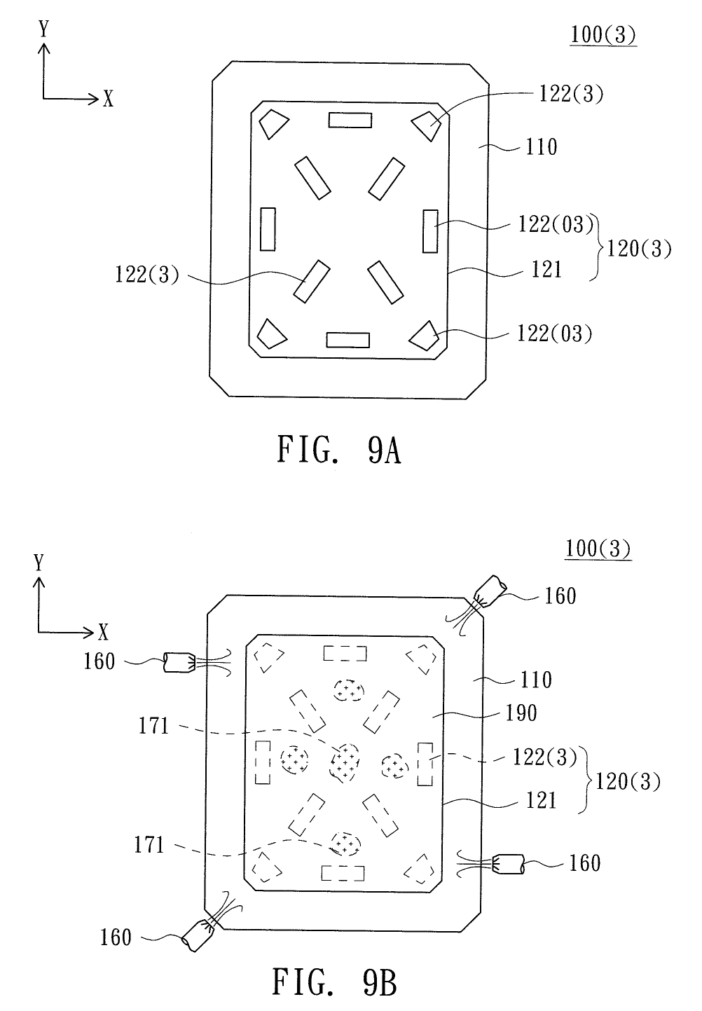

Referring to FIG. 9A. FIG. 9A is a top view of the supporting substrate 110 and the fixing board 120(3) according to the third embodiment of the present invention. In the present embodiment, some of the films 122 are disposed in a place, in which between two opposite corners of the soft film 121. In additional, when the present embodiment, preferred, is incorporated in the first embodiment and/or the second embodiment, due to the films 122(3) are hydrophobic, the liquid 171 flows away from the regions in which the films 122(3) are disposed.

Referring to FIG. 9B. FIG. 9B is a top view of the supporting substrate 110, the fixing board 120(3) and the non-semiconductor substrate 190 according to the third embodiment of the present invention. The hydrophobic films 122(3) of the present embodiment are disposed on four corners, between adjacent corners and between opposite corners of the soft film 121 as an example, the liquid 171 flows away from the soft film 121 quickly. Accordingly, the adhesive force between the non-semiconductor substrate 190 and the soft film 121 is reduced significantly, and the non-semiconductor substrate 190 is prevented from deformation. Therefore, in other words, the films of the above-mentioned embodiments (such as the first, second, third embodiment) disposed in a place, in which at least one of on four corners of the soft film, between two adjacent corners of the soft film, and between two opposite corners of the soft film.

### Fourth Embodiment

The fixing board 120(4) and the polishing device 100(4) using the same of a fourth embodiment and those of the first embodiment are different in the locations of the films 122(4). Other parts are the same and not described repeatedly.

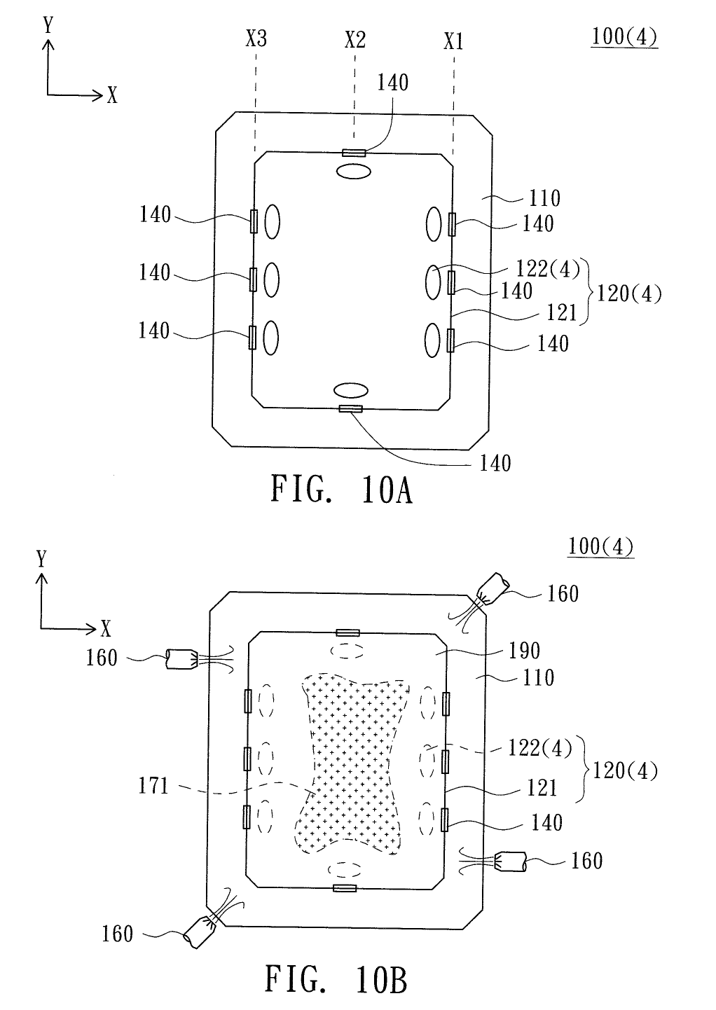

Referring to FIG. 10A. FIG. 10A is a top view of the supporting substrate 110 and the fixing board 120(4) according to the fourth embodiment of the present invention. In the present embodiment, at least part of the films 122(4) are disposed substantially corresponding to the first holders 140. Because the films 122(4) are hydrophobic, the liquid 171 flows away from the regions corresponding to the first holders 140 quickly.

Referring to FIG. 10B. FIG. 10B is a top view of the supporting substrate 110, the fixing board 120(4) and the non-semiconductor substrate 190 according to the fourth embodiment of the present invention. Because at least part of the hydrophobic films 122(4) are disposed substantially corresponding to the first holders 140, the liquid 171 flows away from the regions corresponding to the first holders 140 quickly. Accordingly, the adhesive force between the non-semiconductor substrate 190 and the soft film 121 is reduced significantly, and the non-semiconductor substrate 190 is prevented from deformation.

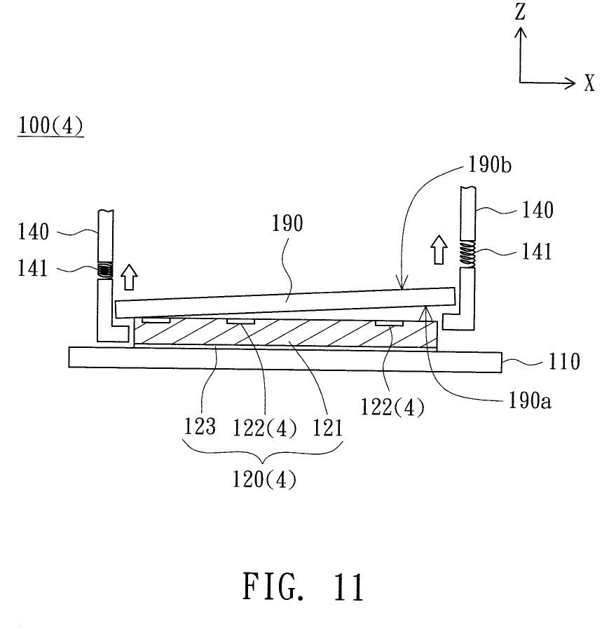

Referring to FIG. 10A and FIG. 11 at the same time. FIG. 11 illustrates the process that the first holders in FIG. 10B lifts up the non-semiconductor substrate. At least part of the first holders 140 has elasticity elements 141. In the present invention, each first holder 140 has one elastic element 141 as an example, shown in FIG. 10A. The elasticity coefficients of the elastic elements 141 are increased incrementally along the reverse of the X direction (−X). The first holders 140 disposed at X3 position have the elasticity coefficients substantially greater than those at X2 position. The first holders at X2 position have the elasticity coefficients substantially greater than those at X1 position. In other words, it is more difficult to lift up the first holders 140 on the left side of the drawings, so the first holders 140 easily to lift up the non-semiconductor substrate 190 from right to left. Accordingly, the liquid 171 flows away from the non-semiconductor 190 along the reverse of the X direction more easily.

Similarly, the elasticity coefficients of the elasticity elements 141 can be increased incrementally along X direction (+X). Or, the elasticity coefficients of the elasticity elements 141 can be increased incrementally along +Y direction or −Y direction. As long as the non-semiconductor substrate can be lifted up smoothly, all modifications can be applied to the present embodiment.

Furthermore, the arrangement of the elasticity coefficients of the elasticity elements 141 can be adjusted according to the adhesive force between the non-semiconductor substrate 190 and the soft film 121. For example, the elasticity coefficients of the elasticity elements 141 are increased incrementally along +X direction and +Y direction, the elasticity coefficients of the elasticity elements 141 are increased incrementally along +X direction and −Y direction, the elasticity coefficients of the elasticity elements 141 are increased incrementally along −X direction and −Y direction, the elasticity coefficients of the elasticity elements 141 are increased incrementally along −X direction and +Y direction, the elasticity coefficients of the elasticity elements 141 are increased incrementally along a random direction, or combinations thereof.

### Fifth Embodiment

The fixing board 120(5) and the polishing device 100(3) using the same of a fifth embodiment and those of the fourth embodiment are different in the locations of the films 122(5). Other parts are the same and not described repeatedly.

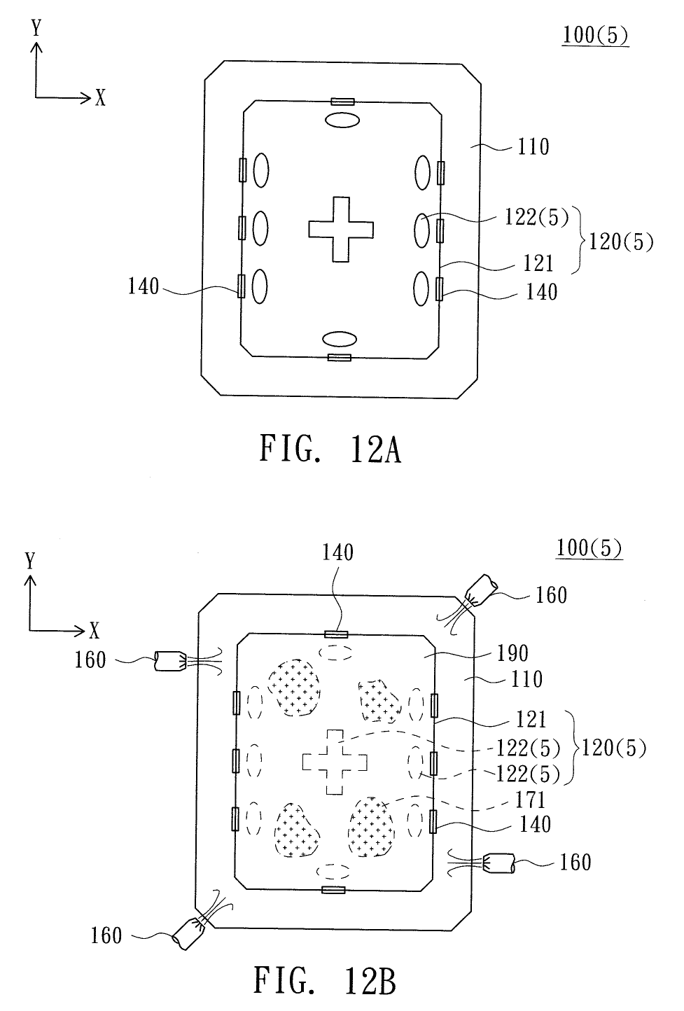

Referring to FIG. 12A. FIG. 12A is a top view of the supporting substrate 110 and the fixing board 120(5) according to the fifth embodiment of the present invention. In the present embodiment, at lest part of the films 122(5) are disposed substantially corresponding to the first holders 140 and disposed on the substantially center of the first surface 190a. Because the films 122(5) are hydrophobic, the liquid 171 flows away from the regions substantially corresponding to the first holders 140 quickly. Also, the liquid 171 does not remain at the substantially center of the non-semiconductor substrate 190.

Referring to FIG. 12B. FIG. 12B is a top view of the supporting substrate 110, the fixing board 120(5) and the non-semiconductor substrate 190 according to the fifth embodiment. When the first holders 140 lift up the non-semiconductor substrate 190, the liquid 171 flows away from the regions substantially corresponding to the first holders 140 quickly. Also, the liquid 171 does not remain at the substantially center of the non-semiconductor substrate 190. Accordingly, the adhesive force between the non-semiconductor substrate 190 and the soft film 121 is reduced significantly, and the non-semiconductor substrate 190 is prevented from deformation.

### Sixth Embodiment

The difference between the fixing board 120(6) and the polishing device 100(6) using the same of a sixth embodiment and those of the fourth embodiment is that the polishing device 100(6) further includes several second holders 150, and the films 122(6) are not disposed substantially corresponding to the second holders 150. Other parts are the same and not described repeatedly.

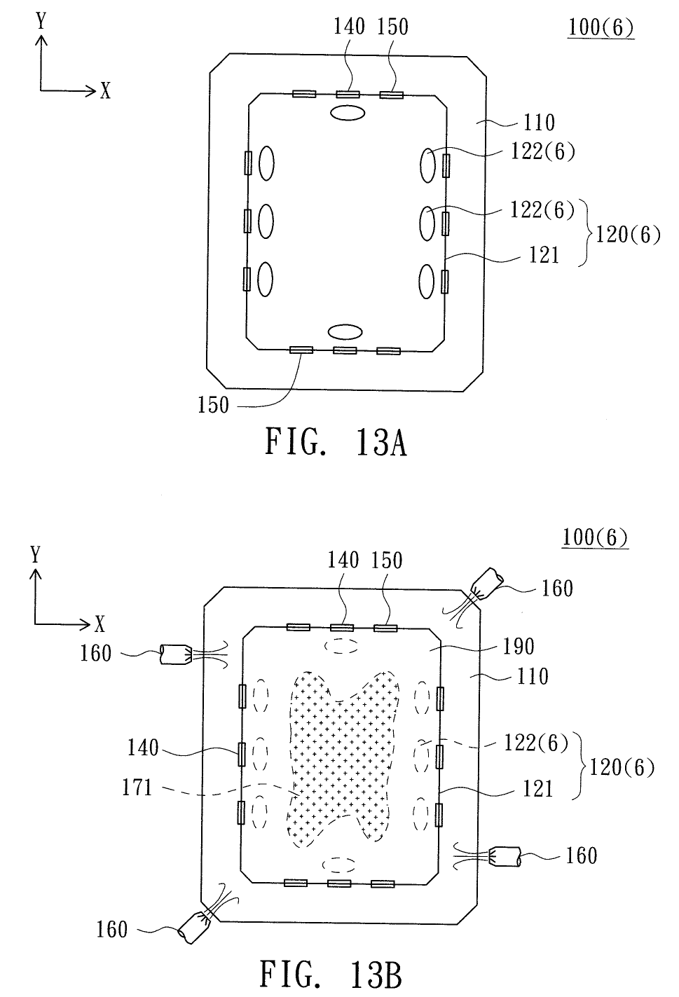

Referring to FIG. 13A. FIG. 13A is a top view of the supporting substrate 110 and the fixing board 120(6) according to the sixth embodiment. In the present embodiment, the films 122(6) are disposed only substantially corresponding to the first holders 140. As a result, a certain level of an adhesive force is between the soft film 121 and the non-semiconductor substrate 190, so the non-semiconductor substrate 190 is not separated from the soft film 121 when rotating. Because the films 122(6) are hydrophobic, the liquid 171 flows away from the regions substantially corresponding to the first holders 140 quickly.

At least one of the at least part of the first holders 140 and the at least part of the second holders 150 have elasticity elements. Preferably, the elasticity coefficients of the elasticity elements and the direction that the first holders 140 and the second holders 150 lift up the non-semiconductor substrate 190 along are designed referring to the fourth embodiment of the present invention.

Referring to FIG. 13B. FIG. 13B is a top view of the supporting substrate 110, the fixing board 120(6) and the non-semiconductor substrate 190 according to the sixth embodiment. When the first holders 140 lift up the non-semiconductor substrate 190, the liquid 171 flows away from the regions between the adjacent first holders 140 quickly. Accordingly, the adhesive force between the non-semiconductor substrate 190 and the soft film 121 is reduced significantly, and the non-semiconductor substrate 190 is prevented from deformation.

### Seventh Embodiment

The fixing board 120(7) and the polishing device 100(7) using the same of a seventh embodiment and those of the fourth embodiment are different in the locations of the films 122(7). Other parts are the same and not described repeatedly.

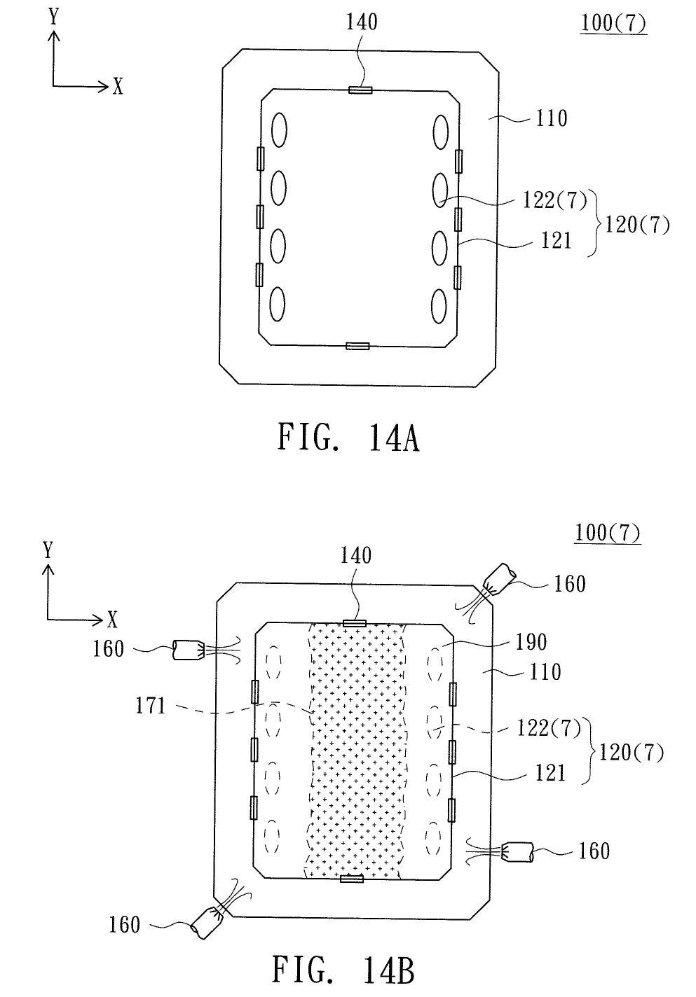

Referring to FIG. 14A. FIG. 14A is a top view of the supporting substrate 110 and the fixing board 120(7) according to the seventh embodiment of the present invention. In the present embodiment, the films 122(7) are not disposed substantially corresponding to the first holders 140.

At least part of the first holders 140 has elasticity elements. Preferably, the elasticity coefficients of the elasticity elements and the direction that the first holders 140 lift up the non-semiconductor substrate 190 along are designed referring to the fourth embodiment of the present invention.

Referring to FIG. 14B. FIG. 14B is a top view of the supporting substrate 110, the fixing board 120(7) and the non-semiconductor substrate 190 according to the seventh embodiment. Due to the films 122(7) are disposed between the adjacent first holders 140 and not substantially corresponding to the first holders 140, it is easy to lift up the regions between the adjacent first holders 140. Accordingly, the adhesive force between the non-semiconductor substrate 190 and the soft film 121 is reduced significantly, and the non-semiconductor substrate 190 is prevented from deformation.

### Eighth Embodiment

The fixing board 120(8) and the polishing device 100(7) using the same of an eighth embodiment and those of the first embodiment are different in the locations of the films 122(8). Other parts are the same and not described repeatedly.

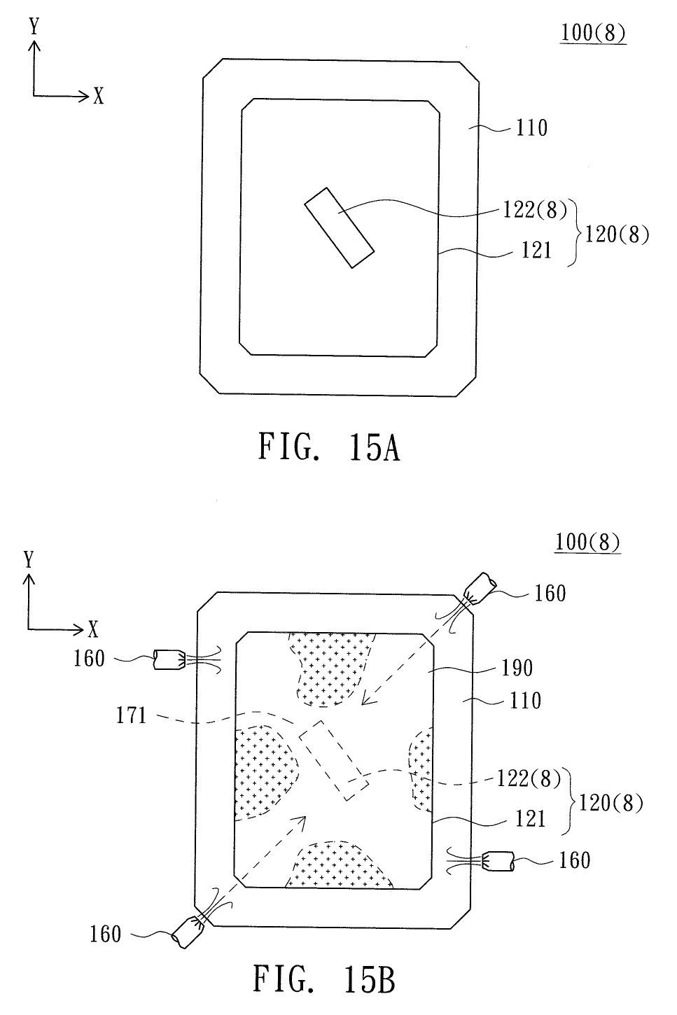

Referring to FIG. 15A. FIG. 15A is a top view of the supporting substrate 110 and the fixing board 120(8) according to the eighth embodiment of the present invention. In the present embodiment, at least part of the films 122(8) is disposed substantially corresponding to the gas injectors 160 and on a flowing path of the gas. Because the sot films 122(8) are hydrophobic, the liquid 171 flows away from the non-semiconductor substrate 190 quickly along the flowing path of the gas.

Referring to FIG. 15B. FIG. 15B is a top view of the supporting substrate 110, the fixing board 120(8) and the non-semiconductor substrate 190 according to the eighth embodiment. Because the films 122(8) are disposed substantially corresponding to the flowing path of the gas, the gas dissipates to the entire non-semiconductor substrate 190 rapidly and drives away the liquid 171. Accordingly, the adhesive force between the non-semiconductor substrate 190 and the soft film 121 is reduced significantly, and the non-semiconductor substrate 190 is prevented from deformation.

Although the films 122(1)˜122(8) are disposed as shown in FIGS. 7A˜15A in the above embodiments as examples, the films of the present invention can be disposed in any region of the soft film 121 according to the polishing device and the non-semiconductor substrate. The present invention encompasses such modifications as long as the films are disposed on the soft film so as to lift the non-semiconductor substrate smoothly.

Although the films 122(1)˜122(8) are substantially trapezoid, substantially rectangular, substantially elliptic, or substantially cross-shaped as shown in FIGS. 7A˜15A, the films of the present invention can be substantially triangular, substantially circular, substantially polygonal, or irregularly shaped. The shape of the films is not limited thereto. The present invention encompasses such modifications as long as the films are disposed on the soft film so as to lift the non-semiconductor substrate smoothly.

In the fixing board and the polishing device of the above embodiments of the present invention, several films are disposed on the soft film so as to lift up the non-semiconductor substrate smoothly. The fixing board and the polishing device of the above-mentioned embodiments of the present invention can be including the following advantages.

1. Because the films are hydrophobic, the liquid flows away from the non-semiconductor substrate quickly in the lifting process. Therefore, the non-semiconductor is not deformed easily, and the substrate is prevented from cracking effectively.

2. The speed of the holder to lift up the non-semiconductor substrate does not need to be reduced for prevent the substrate from cracking. As a result, the manufacturing speed is maintained to a certain level which reduces the manufacturing time.

3. The number of the cracked substrates and the manufacturing time are reduced. Therefore, the manufacturing cost is reduced accordingly.

4. The films are disposed on the soft film, and some of the soft films contact the non-semiconductor substrate. As a result, the non-semiconductor substrate is able to be attached to the soft film and still spins smoothly.

While the present invention has been described by way of example and in terms of a preferred embodiment, it is to be understood that the present invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A fixing board attached to a non-semiconductor substrate, the fixing board comprising:
a soft film; and
a plurality of films disposed on part of the soft film and substantially corresponding to a first surface of the non-semiconductor substrate.

2. The fixing board according to claim 1, wherein the films are disposed in a place, in which at least one of on four corners of the soft film, between two adjacent corners of the soft film, and between two opposite corners of the soft film.

3. The fixing board according to claim 1, wherein the films comprise a hydrophobic material or an oleophilic material.

4. The fixing board according to claim 1, wherein the films comprise teflon, carbon fluoride polymer, polymer, or combinations thereof.

5. The fixing board according to claim 1, wherein the soft film comprises a foam layer.

6. The fixing board according to claim 1, further comprising a supporting base disposed under the soft film.

7. A polishing device comprising:
a supporting substrate adapted to support a non-semiconductor substrate;
a fixing board disposed over the supporting substrate attached to the non-semiconductor substrate, the fixing board comprising:
a soft film; and
a plurality of films disposed on the soft film and substantially corresponding to a first surface of the non-semiconductor substrate;
a polishing plate adapted to polish a second surface of the non-semiconductor substrate; and
a plurality of first holders adapted to hold the non-semiconductor substrate away from the supporting substrate or placed on the supporting substrate;
wherein at least part of the films are substantially corresponding to the first holders.

8. The polishing device according to claim 7, wherein the films are disposed corresponding to a substantially center of the second surface of the non-semiconductor substrate.

9. The polishing device according to claim 7, further comprising a plurality of second holders, and the films are not substantially corresponding to the second holders.

10. The polishing device according to claim 9, wherein at least one of the at least part of the first holders and at least part of the second holders comprise elasticity elements.

11. The polishing device according to claim 7, wherein the films comprise a hydrophobic material or an oleophilic material.

12. The polishing device according to claim 7, wherein the films comprise teflon, carbon fluoride polymer, polymer, or combinations thereof.

13. The polishing device according to claim 7, further comprising:
a fluid injector adapted to inject fluid onto one of the second surface of the non-semiconductor substrate and the first surface of the non-semiconductor substrate.

14. The polishing device according to claim 13, wherein the fluid comprises gas, so that part of the films disposed on a flowing path of the gas.

15. The polishing device according to claim 7, wherein the supporting substrate drives the substrate to rotate, the polishing plate is rotated and contacted on the second surface, and the rotation direction of the supporting substrate and the rotation direction of the polishing plate is substantially different.

16. The polishing device according to claim 7, wherein the soft film comprises a foam layer.

17. The polishing device according to claim 7, further comprising a supporting base disposed under the soft film.

18. A polishing device comprising:
a supporting substrate adapted to support a non-semiconductor substrate;
a fixing board disposed over the supporting substrate attached to the non-semiconductor substrate, the fixing board comprising:
a soft film; and
a plurality of films disposed on the soft film and substantially corresponding to a first surface of the non-semiconductor substrate;
a polishing plate adapted to polish a second surface of the non-semiconductor substrate; and
a plurality of first holders adapted to hold the non-semiconductor substrate away from the supporting substrate or placed on the supporting substrate;
wherein at least part of the films are not substantially corresponding to the first holders.

19. The polishing device according to claim 18, wherein the films comprise a hydrophobic material or an oleophilic material.

20. The polishing device according to claim 19, wherein the films comprise teflon, carbon fluoride polymer, polymer, or combinations thereof.

21. The polishing device according to claim 18, further comprising:
a fluid injector adapted to inject fluid onto one of the second surface of the non-semiconductor substrate and the first surface of the non-semiconductor substrate.

22. The polishing device according to claim 21, wherein the fluid comprises gas, part of the films disposed on a flowing path of the gas.

23. The polishing device according to claim 18, wherein the supporting substrate drives the substrate to rotate, the polishing plate is rotated and contacted on the second surface, and the rotation direction of the supporting substrate and the rotation direction of the polishing plate is substantially different.

24. The polishing device according to claim 18, wherein the soft film comprises a foam layer.

25. The polishing device according to claim 18, further comprising a supporting base disposed under the soft film.

26. The polishing device according to claim 18, wherein at least part of the first holders has elasticity elements.

27. A polishing device comprising:
a supporting substrate adapted to support a non-semiconductor substrate;
a fixing board disposed over the supporting substrate attached to the non-semiconductor substrate, the fixing board comprising:
a soft film; and
a plurality of films disposed on the soft film and substantially corresponding to a first surface of the non-semiconductor substrate;
a polishing plate adapted to polish a second surface of the non-semiconductor substrate; and
a fluid injector adapted to inject fluid onto one of the first surface of the non-semiconductor substrate and the second surface of the non-semiconductor substrate;
wherein at least part of the films are substantially located on a flowing path of the fluid.

28. The polishing device according to claim 27, wherein the films comprise a hydrophobic material or an oleophilic material.

29. The polishing device according to claim 27, wherein the films comprise teflon, carbon fluoride polymer, polymer, or combinations thereof.

30. The polishing device according to claim 27, wherein the supporting substrate drives the substrate to rotate, the polishing plate is rotated and contacted on the second surface, and the rotation direction of the supporting substrate and the rotation direction of the polishing plate is substantially different.

31. The polishing device according to claim 27, wherein the soft film comprises a foam layer.

32. The polishing device according to claim 27, further comprising a supporting base disposed under the soft film.
